(19) United States
(12) Patent Application Publication
(10) Pub. No.: US 2006/0281894 A1
(43) Pub. Date: Dec. 14, 2006

(54) Method of forming polyetherols in the presence of aluminum phosphate catalysts

(75) Inventor: Edward Michael Dexheimer, Grosse Ile, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation.

(21) Appl. No.: 11/151,618

(22) Filed: Jun. 13, 2005

(51) Int. Cl. C08G 65/04

(52) U.S. Cl. 528/416

(57) ABSTRACT

A polyether polyol is formed by a method utilizing an aluminum phosphate catalyst. The method includes providing an alkylene oxide, providing an initiator molecule having at least one alkylene oxide reactive hydrogen, and reacting the alkylene oxide with the initiator molecule in the presence of the aluminum phosphate catalyst or a residue of the aluminum phosphate catalyst. The aluminum phosphate catalyst may have the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group.

### TECHNICAL FIELD

The present invention generally relates to a polyether polyol and a method of forming the polyether polyol in the presence of an aluminum phosphate catalyst.

### BACKGROUND OF THE INVENTION

Polyoxyalkylene polyether polyols are well known compounds. These polyether polyols are utilized, in conjunction with a cross-linking agent, such as an organic isocyanate, to form or produce a variety of polyurethane products, foamed and non-foamed, i.e., elastomeric, such as polyurethane foams and polyurethane elastomers. As a general matter, these polyols are produced by polyoxyalkylation of an initiator molecule with an alkylene oxide such as ethylene oxide, propylene oxide, butylene oxides, or mixtures thereof. The initiator molecules contain alkylene oxide-reactive hydrogens like those found in hydroxyl groups and amine groups. This oxyalkylation is generally conducted in the presence of a catalyst.

The most common catalysts are basic metal catalysts such as sodium hydroxide, potassium hydroxide, or alkali metal alkoxides. One advantage of these basic metal catalysts is that they are inexpensive and readily available. Use of these basic metal catalysts, however, is associated with a range of problems. One of the major problems is that oxyalkylation with propylene oxide has associated with it a competing rearrangement of the propylene oxide into allyl alcohol, which continually introduces a monohydroxyl-functional molecule. This monohydroxyl-functional molecule is also capable of being oxyalkylated. In addition, it can act as a chain terminator during the reaction with isocyanates to produce the final polyurethane product. Thus, as the oxyalkylation reaction is continued more of this unwanted product, generally measured as the unsaturation content of the polyol, is formed. This leads to reduced functionality and a broadening of the molecular weight distribution of the polyol. The amount of unsaturation content may approach 30 to 40 molar % with unsaturation levels of 0.090 meq KOH/g or higher.

In an attempt to reduce the unsaturation content of polyether polyols, a number of other catalysts have been developed. One such group of catalysts includes the hydroxides formed from rubidium, cesium, barium, and strontium. These catalysts also present a number of problems. The catalysts only slightly reduce the degree of unsaturation, are much more expensive, and some are toxic.

A further line of catalyst development for polyether polyol production focuses on double metal cyanide (DMC) catalysts. These catalysts are typically based on zinc hexacyanocobaltate. With the use of DMC catalysts, it is possible to achieve relatively low unsaturation content in the range of 0.003 to 0.010 meq KOH/g. While the DMC catalysts would seem to be highly beneficial they also are associated with a number of difficulties. As a first difficulty, there is a relatively high capital cost involved in scaling up of and utilization of DMC catalysts. The catalysts themselves have an extremely high cost compared to the basic metal catalysts. Further, when forming a polyether polyol using a DMC catalyst, there is a significant initial lag time before the DMC catalyst begins to catalyze the reaction. It is not possible to add ethylene oxide onto growing polyol chains utilizing DMC catalysts. To add ethylene oxide to a growing chain, the DMC catalysts must be replaced with the typical basic metal catalysts, thus adding complexity and steps. In addition, it is generally believed that the DMC catalysts should be removed prior to work-up of any polyether polyol for use in forming polyurethane products. Finally, polyether polyols generated using DMC catalysts are not mere “drop in” replacements for similar size and functionality polyols produced using the typical basic metal catalysts. Indeed, it has been found that often DMC catalyzed polyether polyols have properties very different from equivalent polyether polyols produced using, for example, potassium hydroxide.

A more recent line of catalyst development for polyether polyol production focuses on aluminum phosphonate catalysts. However, aluminum phosphonate-based catalysts also have drawbacks. Aluminum phosphonate catalysts are produced via the reaction of a pentavalent phosphonic acid and a tri-substituted aluminum compound, and it is known that phosphonic acid is unduly expensive.

Thus, there exists a need for a class of catalysts that can be used for the oxyalkylation of initiator molecules by alkylene oxides that are inexpensive, capable of producing very low unsaturation polyether polyols, do not require removal from the polyether polyol prior to utilization to form a polyurethane product, and that produce a polyether polyol having properties that are the same or better than those in polyether polyols produced using basic metal catalysts. It would also be beneficial if the new class of catalysts could be used in existing systems and equipment using standard manufacturing conditions.

### SUMMARY OF THE INVENTION AND ADVANTAGES

A polyether polyol is formed according to a method of the present invention. At least one alkylene oxide and at least one initiator molecule are provided. The initiator molecule has at least one alkylene oxide reactive hydrogen. The at least one alkylene oxide is reacted with the at least one initiator molecule in the presence of an aluminum phosphate catalyst or residue thereof to form the polyether polyol.

Importantly, the aluminum phosphate catalyst utilized in the present invention remains soluble in polyether polyols and has catalytic activity comparable to, if not exceeding that of, the basic metal and DMC catalysts. When the aluminum phosphate catalyst is used in the oxyalkylation of initiator molecules by alkylene oxides, very low unsaturation (e.g. less than 0.080 meq KOH/g such as less than or equal to 0.020 meq KOH/g) polyether polyols are formed. Furthermore, the aluminum phosphate catalyst is inexpensive as compared to the aluminum phosphonate and DMC catalysts of the prior art. The aluminum phosphate catalyst is produced via the reaction of a phosphoric acid and a tri-substituted aluminum compound. Phosphoric acid is inexpensive as compared to the phosphonic acids. Furthermore, there is no need to remove, by neutralization and filtration, the aluminum phosphate catalyst or any of its residues from the polyether polyol prior to use of the polyether polyol in forming polyurethane products. Physical properties of polyether polyols that are produced with aluminum phosphate catalysts are not negatively impacted, and the aluminum phosphate catalysts can be used in existing systems and equipment using standard manufacturing conditions.

### DETAILED DESCRIPTION

A polyether polyol, i.e., polyetherol, and a method of forming the polyether polyol are disclosed. Generally, the method uses an aluminum phosphate catalyst to form the polyether polyol. Use of the aluminum phosphate catalyst enables production of polyether polyols having very low unsaturation as compared to a similarly sized polyether polyols produced using typical basic metal catalysts. In addition, other than the very low degree of unsaturation, polyether polyols formed via catalysis with aluminum phosphate catalysts have properties that are the same or better than those produced using the typical basic metal catalysts. The aluminum phosphate catalysts can be synthesized in a very straightforward manner and are inexpensive compared to the other catalysts capable of producing these very low unsaturation polyether polyols. We have also found that aluminum phosphate catalysts do not have to be removed after formation of the polyether polyol prior to its use in forming, i.e., producing, a polyurethane product. The polyurethane product can be foamed or non-foamed, i.e., elastomeric, and is described additionally below. The aluminum phosphate catalysts can be readily substituted in existing oxyalkylation procedures that utilize basic metal catalysts, such as potassium hydroxide, with virtually no modifications to the procedure. Unlike the DMC class of catalysts, these aluminum phosphate catalysts used in the present invention exhibit no lag time and are capable of polyoxyalkylation utilizing ethylene oxide.

The method includes the step of providing at least one alkylene oxide. Suitable alkylene oxides include, but are not limited to, ethylene oxide, propylene oxide, butylene oxide, epichlorohydrin or mixtures of these alkylene oxides. As is known, alkylene oxides are used to polyoxyalkylate an initiator molecule, described additionally below, to form polyether polyols.

The method also includes the step of providing at least one initiator molecule. As understood by those skilled in the art, the initiator molecule has at least one alkylene oxide reactive hydrogen. More preferred alkylene oxides have at least two alkylene oxide reactive hydrogens. Suitable initiator molecules include, but are not limited to, an alcohol, a polyhydroxyl compound, a mixed hydroxyl and amine compound, an amine, a polyamine compound, or mixtures of these initiator molecules. Examples of alcohols include, but are not limited to, aliphatic and aromatic alcohols, such as lauryl alcohol, nonylphenol, octylphenol and C₁₂ to C₁₈ fatty alcohols. Examples of the polyhydroxyl compounds include, but are not limited to, diols, triols, and higher functional alcohols such as sucrose and sorbitol. Examples of amines include, but are not limited to, aniline, dibutylamine, and C₁₂ to C₁₈ fatty amines. Examples of polyamine compounds include, but are not limited to, diamines such as ethylene diamine, toluene diamine, and other polyamines.

In a preferred embodiment, a pre-reaction initiator molecule is pre-reacted with at least one alkylene oxide to form an oligomer. Typically, such an oligomer has a number average molecular weight of from 200 to 1,500 Daltons. The oligomer is then used as the initiator molecule and reacted with the alkylene oxide in the presence of the aluminum phosphate catalyst to form the polyether polyol as described below. Suitable pre-reaction initiator molecules include those described above in the context of the initiator molecule.

The at least one alkylene oxide is reacted with the at least one initiator molecule in the presence of the aluminum phosphate catalyst or residue thereof to form the polyether polyol. Without intending to be bound by theory, the aluminum phosphate catalyst may undergo exchange reactions to some extent with the initiator molecule(s) in a reversible manner to form a modified aluminum phosphate, which is also catalytically active. This modified aluminum phosphate is also referred to as a residue. Preferably, the initiator molecule and the alkylene oxide or oxides are reacted in the presence of the aluminum phosphate catalyst for a period of time from 15 minutes to 15 hours. Typically, this period of time is sufficient to form polyether polyols having an equivalent weight of from 100 to 10,000, more preferably 200 to 2,000, and most preferably from 500 to 2,000, Daltons. The reaction between the initiator molecule and the alkylene oxide is generally conducted at a temperature of from 95° C. to 150° C., and more preferably at a temperature of from 105° C. to 130° C.

Generally, the aluminum phosphate catalysts are utilized in an amount of from 0.1 to 5.0 weight percent based on the total weight of the polyether polyol, more preferably at levels of from 0.1 to 0.5 weight percent on the same basis. The aluminum phosphate catalysts utilized in the present invention may be water sensitive. As such, although not required, it is preferable that water levels of all components used in formation of the polyether polyol be at or below 0.1 weight percent of the particular component, more preferably at or below 0.05 weight percent.

The aluminum phosphate catalyst preferably has the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group. Examples of suitable haloalkyl groups include, but are not limited to, chloromethyl groups and trifluoromethyl groups. In preferred embodiments of the present invention, R′ and R″ independently comprise one of an ethyl group, an ethoxy group, a propyl group, a propoxy group, a butyl group, a butoxy group, a phenyl group, or a phenoxy group.

The aluminum phosphate catalysts of the present invention can be produced by a number of processes, one of which is described in detail below in the Examples. In general, the procedure involves reacting phosphoric acid and a tri-substituted aluminum compound to produce the aluminum phosphate catalyst. As is known, the phosphoric acid has the structure of PO(OH)₃, wherein: P represents a pentavalent phosphorous; O represents oxygen; and H represents hydrogen. The tri-substituted aluminum compounds have the general structure of AlR′₃, wherein: R′ is a methyl group, an alkyl group, an alkoxy group, an aryl group, or an aryloxy group. Some examples include, but are not limited to, trimethylaluminum, triethylaluminum, triethoxyaluminum, tri-n-propylaluminum, tri-n-propoxyaluminum, tri-iso-propoxyaluminum, tri-iso-butylaluminum, tri-sec-butylaluminum, tri-iso-butoxyaluminum, tri-sec-butoxyaluminum, tri-tert-butoxyaluminum, triphenylaluminum, and tri-phenoxyaluminum.

The polyether polyols formed via the reaction of the at least one alkylene oxide with the at least one initiator molecule in the presence of the aluminum phosphate catalyst according to the present invention have very low unsaturation. More specifically, the polyether polyols formed according to the present invention typically have an unsaturation of less than or equal to 0.020 meq KOH/g, more preferably less than or equal to 0.015 meq KOH/g, and most preferably less than or equal to 0.010 meq KOH/g. Furthermore, as described above, the polyether polyols formed according to the present invention typically have an equivalent weight of from 100 to 10,000, more preferably 200 to 2,000, and most preferably from 500 to 2,000, Daltons. The polyether polyols formed according to the method of the present invention include, after formation of the polyether polyol, the aluminum phosphate catalyst or residue thereof. That is, the polyether polyol can comprise the aluminum phosphate catalyst or residue thereof. If so, the aluminum phosphate catalyst is preferably present in an amount of from 0.1 to 5.0 weight percent based on the total weight of the polyether polyol. The aluminum phosphate catalyst or its residue can even remain in the polyether polyol as the polyether polyol is used to make polyurethane products. There is no need to remove, by neutralization and/or filtration, the aluminum phosphate catalyst or any of its residues from the polyether polyol prior to use of the polyether polyol to form polyurethane products. Remaining amounts of the aluminum phosphate catalyst in the polyether polyol and, ultimately, in the final polyurethane product do not negatively impact the desired properties in the final polyurethane product. Optionally, it is to be understood that the remaining amounts of the aluminum phosphate catalyst can be removed by methods known and understood by those skilled in the art as desired.

As described immediately below, the polyether polyol is used in conjunction with a cross-linking agent, such as an organic isocyanate (including an organic polyisocyanates) and/or an isocyanate pre-polymer, to produce the polyurethane product. The polyether polyol has reactive hydrogens. It is to be understood that the polyether polyol can be included in a polyol component having at least one of the polyether polyols and, preferably, including a blend of more than one polyether polyol. Preferably, the polyether polyol has an equivalent weight of from about 100 to about 10,000.

The polyurethane product is formed by reacting at least one organic isocyanate and/or isocyanate pre-polymer with the polyether polyol. More specifically, the organic isocyanate and/or isocyanate pre-polymer have functional groups that are reactive to the reactive hydrogens of the polyether polyol. Suitable organic isocyanates include, but are not limited to, diphenylmethane diisocyanate (MDI), toluene diisocyanate (TDI), polymeric diphenylmethane diisocyanate (PMDI), and mixtures thereof.

In addition to the polyether polyol, other additional substances having reactive hydrogens may also participate in the reaction. Examples of such additional substances include, but are not limited to, amines and chain extenders, such as diols and triols. The polyether polyol and the organic isocyanate and/or isocyanate pre-polymer may, optionally, be reacted in the presence of a urethane promoting catalyst and certain additives including, but not limited to, blowing agents (if the polyurethane product is foamed), cross-linkers, surfactants, flame retardants, fillers, pigments, antioxidants, and stabilizers. The urethane promoting catalyst is different than the aluminum phosphate catalyst. The polyurethane products formed according to the methods of the present invention include flexible foams, semi-rigid foams, rigid foams, coatings, and elastomers such as adhesives, sealants, thermoplastics, and combination thereof.

As alluded to above, the aluminum phosphate catalyst or its residue can remain in the polyether polyol as the polyether polyol is used to make polyurethane products. In other words, there is no need to remove, by neutralization and/or filtration, the aluminum phosphate catalyst or any of its residues from the polyether polyol prior to use of the polyether polyol to form polyurethane products. As such, in one embodiment of the present invention, the polyurethane product comprises greater than 0.001, more preferably from 0.001 to 5.0, weight percent of aluminum phosphate catalyst and/or aluminum phosphate catalyst residues based on the total weight of the polyurethane product. In this particular embodiment, although not required, the aluminum phosphate catalyst is preferably of the general structure of P(O)(OAlR′R″)₃ wherein 0, P, Al, R′, and R″ are as described above. It is preferred that R′ and R″ independently comprise one of an ethyl group, an ethoxy group, a propyl group, a propoxy group, a butyl group, a butoxy group, a phenyl group, or a phenoxy group.

The present invention also includes a particular composition of matter. The composition of matter includes a polyurethane material and the aluminum phosphate catalyst or residues of the aluminum phosphate catalyst. The polyurethane material can be the final polyurethane product. In any event, the polyurethane material is the reaction product of the polyether polyol and an organic isocyanate (including organic polyisocyanates) and/or isocyanate pre-polymer. Also, the polyurethane material can be foamed or non-foamed, i.e., elastomeric, and is, therefore, preferably selected from the group of flexible foams, semi-rigid foams, rigid foams, and elastomers such as coatings, adhesives, sealants, thermoplastics, and combinations thereof. In this embodiment of the composition of matter, the aluminum phosphate catalyst is preferably present in an amount of from approximately 0.001 to 5.0 weight percent based on the total weight of the polyurethane material, and the aluminum phosphate catalyst has the general structure of P(O)(OAlR′R″)₃ wherein 0, P, Al, R′, and R″ are as described above. Preferably, R′ and R″ independently comprise one of an ethyl group, an ethoxy group, a propyl group, a propoxy group, a butyl group, a butoxy group, a phenyl group, or a phenoxy group.

### EXAMPLES

The following Examples illustrate the nature of the subject method invention with regard to the synthesis of the aluminum phosphate catalyst and with regard to the formation of polyether polyols in the presence of the aluminum phosphate catalyst. The Examples presented herein are intended to illustrate, and not to limit, the subject invention.

### Example 1

### Synthesis of Tris(di-sec-butoxyaluminum) Phosphate

To produce, for example, Tris(di-sec-butoxyaluminum) phosphate as the aluminum phosphate catalyst, the procedure more specifically includes placing a solution of 147.6 g (0.6 mole) of aluminum tri-sec-butoxide in 600 ml of dry THF in a 3 L round bottom flask equipped with mechanical stirring and a nitrogen atmosphere. The solution is cooled to 0° C. in a dry ice/isopropanol mixture. A solution of 17.0 g (0.2 mole) of polyphosphoric acid in 400 ml of isopropyl alcohol cooled to 0° C. is prepared by stirring magnetically in a nitrogen atmosphere. The solution is rapidly added to the flask thereby creating a clear, pink solution. After stirring 0.5 hr., the solution is allowed to warm to room temperature and stand overnight. The reaction mixture is then concentrated under vacuum, diluted with 500 ml of toluene, and further concentrated to a slightly viscous clear solution weighing 307.3 g, which represents ˜30% of the aluminum phosphate catalyst in toluene.

### Example 2

### Formation of a Polyether Polyol

4.0 g of the aluminum phosphate catalyst solution of Example 1 is dissolved in 40.0 g of PLURACOL® Polyol P-410 (400 mol. wt. polypropylene glycol) and this solution is charged to a 500 ml round bottom flask equipped with magnetic stirring, a thermocouple probe, and a dry ice condenser. The solution is heated to 105° C. and 95 g propylene oxide is added dropwise at a rate which maintains a slow reflux from the dry ice condenser. After addition of the propylene oxide is complete, heating and stirring is continued for 1 hour. Volatiles are removed from the final polyether polyol by stirring and heating the polyether polyol at 95° C. and at <10 mm Hg for 1 hour. The polyether polyol weighs 132.5 g.

### Example 3

### Formation of a Polyether Polyol

80 g of the aluminum phosphate catalyst solution of Example 1 and 730 g of PLURACOL® Polyol GP 730, a 700 mol. wt. glycerin propoxylate, are charged to a 1-gallon autoclave. The autoclave is sealed, heated to 120° C., and stripped of volatiles for 0.5 hour at <10 mm Hg. The vacuum is relieved with nitrogen. Propylene oxide is added at <90 psig until 2,239 g are added. Heating and stirring are continued for 5 hours after addition is complete. The autoclave is evacuated to <10 mm Hg for 1 hour and is vented to 0 psig with nitrogen. The polyether polyol weighs 2934 g, representing a 96% yield. Analysis by gel permeation chromatography shows the peak molecular weight to be 2223 Daltons which corresponds to an equivalent weight of 740 Daltons.

### Example 4

### Formation of a Polyether Polyol/Oxypropylenation of a Diol Initiator Molecule

A 1 gallon nitrogen flushed autoclave is charged with 400 g of a polypropylene glycol having a number average molecular weight of 700 and 100 g of a 25% by weight solution of Tris(di-sec-butoxyaluminum) phosphate in toluene and tetrahydrofuran, with agitation. The solvent is removed by batch vacuum stripping at 110° C. for 0.5 hours. Then 1886 g of propylene oxide is fed into the autoclave at a rate of approximately 300 g/hour, at 110° C. and a pressure of less than 90 psig. The contents are reacted to constant pressure at 110° C. for approximately 5 hours. The autoclave is then evacuated to less than 10 mm Hg for 60 minutes. The vacuum is then relieved. The resultant polyetherol is a clear fluid having a number average molecular weight of about 5000, a hydroxyl number of about 22 meq KOH/g, and an unsaturation of less than about 0.010 meq KOH/g.

### Example 5

### Formation of a Polyether Polyol/Oxypropylenation of a Triol Initiator Molecule

A 5 gallon nitrogen flushed autoclave is charged with 1900 g of a glycerin propylene oxide adduct oligomer having a number average molecular weight of 700 and 220 g of a 25% by weight solution of Tris(di-sec-butoxyaluminum) phosphate in toluene and tetrahydrofuran, with agitation. The solvent is removed by batch vacuum stripping at 110° C. for 0.5 hours. Then 14100 g of propylene oxide is fed into the autoclave at a rate of approximately 1000 g/hour, at 110° C. and a pressure of less than 90 psig. The rate of propylene oxide addition is adjusted as needed to maintain the concentration of unreacted propylene oxide at or below 8%. The contents are reacted to constant pressure at 110° C. for approximately 5 hours. The autoclave is then evacuated to less than 10 mm Hg for 60 minutes. The vacuum is then relieved with nitrogen, the contents cooled to 105° C. and transferred to a standard filter mix tank for removal of the catalyst. The contents are treated with 500 g of Magnesol® and 120 g of water for 1 hour at 105° C. The treated contents are recycled through the filter element until the filtrate is haze free indicating full removal of the particulate Magnesol® with bound catalyst. These filtration procedures are well known in the art and can comprise use of systems as simple as Buchner funnels with medium weight filter paper designed to remove particles in the size range of greater than 50 to 100 microns. The filtrate was then heated to 105° C. and vacuum stripped at less than 10 mm Hg for 1 hour. After 1 hour the vacuum is relieved with nitrogen. The clear fluid polyetherol has a number average molecular weight of about 6000, a hydroxyl number of about 28 meq KOH/g, and an unsaturation of less than about 0.010 meq KOH/g.

### Example 6

### Formation of a Polyether Polyol/Oxyalkylenation of a Triol Initiator Molecule

A 5 gallon nitrogen flushed autoclave is charged with 3528 g of a glycerin propylene oxide adduct oligomer having a number average molecular weight of 700 and 250 g of a 25% by weight solution of Tris(di-sec-butoxyaluminum) phosphate in toluene and tetrahydrofuran, with agitation. The solvent is removed by batch vacuum stripping at 110° C. for 0.5 hours. Then a mixture of 8304 g of propylene oxide and 2010 g of ethylene oxide is fed into the autoclave at a rate of approximately 1000 g/hour, at 110° C. and a pressure of less than 90 psig. The contents are reacted to constant pressure at 110° C. for approximately 3 hours. The autoclave is then vented to 34 psig and 1780 g of propylene oxide is fed at a rate of 2000 g/hour into the autoclave at 110° C. and a pressure of less than 90 psig. The contents are reacted to constant pressure at 110° C. for no more than 5 hours. The autoclave is then evacuated to less than 10 mm Hg for 60 minutes. Then the vacuum is relieved with nitrogen and the polyol recovered. The clear fluid polyetherol has a number average molecular weight of about 2000-2500, a hydroxyl number of about 75 meq KOH/g, and an unsaturation of less than about 0.020 meq KOH/g.

### Example 7

### Formation of a Polyether Polyol/Oxyalkylenation of a Triol Initiator Molecule

A 1 gallon nitrogen flushed autoclave is charged with 700 g of a glycerin propylene oxide adduct oligomer having a number average molecular weight of 700 and 100 g of a 25% by weight solution of Tris(di-sec-butoxyaluminum) phosphate in toluene and tetrahydrofuran, with agitation. The solvent is removed by batch vacuum stripping at 110° C. for 0.5 hours. Then 2020 g of propylene oxide is fed into the autoclave at a rate of approximately 1000 g/hour, at 110° C. and a pressure of less than 90 psig. The contents are reacted to constant pressure at 110° C. for approximately 3 hours. The autoclave is then vented to 34 psig and 415 g of ethylene oxide is fed at a rate of 400 g/hour at 110° C. and a pressure of less than 90 psig. The contents are reacted to constant pressure at 110° C. for approximately 3 hours. The autoclave is then evacuated to less than 10 mm Hg for 60 minutes. Then the vacuum is relieved with nitrogen and the polyol recovered. The clear fluid polyetherol has a number average molecular weight of about 3000-3500, a hydroxyl number of about 50-56 meq KOH/g, and an unsaturation of about 0.010 meq KOH/g.

### Example 8

### Formation of a Polyether Polyol/Terminal Capping with Ethylene Oxide of a Triol Oligomer

A 1 gallon nitrogen flushed autoclave is charged with 2000 g of a glycerin propylene oxide adduct oligomer having a number average molecular weight of 3200 and 25 g of an approximately 40% by weight solution of Tris(di-sec-butoxyaluminum) phosphate in toluene and tetrahydrofuran, with agitation. The solvent is removed by batch vacuum stripping at 125° C. for 0.5 hours. Then 360 g of ethylene oxide is fed into the autoclave at a rate of approximately 600 g/hour, at 130° C. and a pressure of less than 90 psig. The contents are reacted to constant pressure at 130° C. for approximately 1 hour. The autoclave is then evacuated to less than 10 mm Hg for 60 minutes. Then the contents are cooled to 80° C., the vacuum is relieved with nitrogen and the polyol is recovered. The clear fluid polyetherol has a number average molecular weight of about 5000 and a hydroxyl number of about 35 meq KOH/g, indicating addition of approximately 38 ethylene oxides per oligomer.

### Example 9

### Comparison of KOH Catalyzed Polyols with Aluminum Phosphate Catalyzed Polyols

Three different sized polyether polyols (Examples 9A-9C) are prepared using a triol initiator molecule and KOH catalyst. More specifically, Example 9A is alkoxylated with propylene oxide. Examples 9B and 9C are alkoxylated with propylene oxide and then capped with ethylene oxide. The physical properties associated with these comparative polyether polyols are presented in Table 1 below.

TABLE 1

| | Number | | | | |
|---|---|---|---|---|---|
| Example | average | Hydroxyl | | | Actual |
| (Catalyst | molecular | number | Unsaturation | Theoretical | Functionality |
| Used) | weight | meq KOH/g | meq KOH/g | Functionality | (due to unsaturation) |
| 9A | 3,366 | 50.0 | 0.028 | 3.00 | 2.81 |
| (KOH) | | | | | |
| 9B | 4,808 | 35.0 | 0.050 | 3.00 | 2.57 |
| (KOH) | | | | | |
| 9C | 6,327 | 26.6 | 0.090 | 3.00 | 2.17 |
| (KOH) | | | | | |

The above examples demonstrate the extraordinary value of the method of the present invention which uses the aluminum phosphate catalysts. The polyether polyols produced using the aluminum phosphate catalysts have a much higher functionality, as compared to polyether polyols produced using the KOH catalyst, due to the much lower unsaturation level for similarly sized polyols. Those skilled in the art recognize that actual functionality can be calculated from the theoretical functionality, the hydroxyl number, and the amount of the unsaturation formed.

The aluminum phosphate catalysts can be used in the present invention to provide terminal capping of polyols with an alkylene oxide. The suitable alkylene oxides include ethylene oxide, propylene oxide, butylene oxide and epichlorohydrin, among others. When capping with the ethylene oxide, the amount of terminal cap preferably ranges from 5 to 80% by weight based on the total weight of the polyetherol, and more preferably 5 to 20% by weight. When capping with propylene oxide, the amount of terminal cap preferably ranges from 5 to 80% by weight based on the total weight of the polyetherol, and more preferably 5 to 15% by weight.

The invention has been described in an illustrative manner, and it is to be understood that the terminology which has been used is intended to be in the nature of words of description rather than of limitation. Obviously, many modifications and variations of the present invention are possible in view of the above teachings. It is, therefore, to be understood that within the scope of the claims the invention may be practiced otherwise than as specifically described.

What is claimed is:

1. A method of forming a polyether polyol, said method comprising the steps of:
a) providing at least one alkylene oxide;
b) providing at least one initiator molecule having at least one alkylene oxide reactive hydrogen; and
c) reacting the at least one alkylene oxide with the at least one initiator molecule in the presence of an aluminum phosphate catalyst or residue thereof to form the polyether polyol.

2. The method of claim 1 wherein step a) comprises providing ethylene oxide, propylene oxide, butylene oxide, epichlorohydrin or mixtures of these alkylene oxides.

3. The method of claim 1 wherein step b) comprises providing as the at least one initiator molecule, an alcohol, a polyhydroxyl compound, a mixed hydroxyl and amine compound, an amine, a polyamine compound, or mixtures of these initiator molecules.

4. The method of claim 3 wherein step b) comprises the further step of pre-reacting the initiator molecule with at least one alkylene oxide to form an oligomer and then using the oligomer as the initiator molecule in step c).

5. The method of claim 4 comprising forming an oligomer having a number average molecular weight of from 200 to 1,500 Daltons.

6. The method of claim 1 wherein step c) comprises providing the aluminum phosphate catalyst in an amount of from 0.1 to 5.0 weight percent based on the total weight of the polyether polyol.

7. The method of claim 1 wherein step c) comprises providing as the aluminum phosphate catalyst an aluminum phosphate having the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group.

8. The method of claim 7 wherein R′ and R″ independently comprise one of an ethyl group, an ethoxy group, a propyl group, a propoxy group, a butyl group, a butoxy group, a phenyl group, or a phenoxy group.

9. The method of claim 1 wherein step c) comprises reacting the at least one alkylene oxide with the at least one initiator molecule in the presence of the aluminum phosphate catalyst to form a polyether polyol having an unsaturation of less than or equal to 0.020 meq KOH/g.

10. The method of claim 1 wherein step c) comprises reacting the at least one alkylene oxide with the at least one initiator molecule in the presence of the aluminum phosphate catalyst for a period of time from 15 minutes to 15 hours.

11. The method of claim 1 wherein step c) comprises reacting the at least one alkylene oxide with the at least one initiator molecule in the presence of the aluminum phosphate catalyst for a period of time sufficient to form a polyether polyol having an equivalent weight of from 100 to 10,000 Daltons.

12. The method of claim 1 wherein step c) comprises reacting the at least one alkylene oxide with the at least one initiator molecule in the presence of the aluminum phosphate catalyst at a temperature of from 95° to 150° C.

13. A method of forming a polyether polyol, said method comprising the steps of:
a) providing at least one alkylene oxide;
b) providing at least one initiator molecule having at least two alkylene oxide reactive hydrogens;
c) providing an aluminum phosphate catalyst or residue thereof wherein the aluminum phosphate catalyst has the general structure of P(O)(OAlR′R″)₃ and wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group; and
d) reacting the at least one alkylene oxide with the at least one initiator molecule in the presence of the aluminum phosphate catalyst or residue thereof to form the polyether polyol.

14. The method of claim 13 wherein step a) comprises providing ethylene oxide, propylene oxide, butylene oxide, epichlorohydrin or mixtures of these alkylene oxides.

15. The method of claim 13 wherein step b) comprises providing as the at least one initiator molecule a polyhydroxyl compound, a mixed hydroxyl and amine compound, a polyamine compound, or mixtures of these initiator molecules.

16. The method of claim 13 wherein step b) comprises the further step of pre-reacting the initiator molecule with at least one alkylene oxide to form an oligomer and then using the oligomer as the initiator molecule in step d).

17. The method of claim 16 comprising forming an oligomer having a number average molecular weight of from 200 to 1,500 Daltons.

18. The method of claim 13 wherein step c) comprises providing the aluminum phosphate catalyst in an amount of from 0.1 to 5.0 weight percent based on the total weight of the polyether polyol.

19. The method of claim 13 wherein R′ and R″ independently comprise one of an ethyl group, an ethoxy group, a propyl group, a propoxy group, a butyl group, a butoxy group, a phenyl group, or a phenoxy group.

20. The method of claim 13 wherein step d) comprises reacting the at least one alkylene oxide with the at least one initiator molecule in the presence of the aluminum phosphate catalyst to form a polyether polyol having an unsaturation of less than or equal to 0.020 meq KOH/g.

21. The method of claim 13 wherein step d) comprises reacting the at least one alkylene oxide with the at least one initiator molecule in the presence of the aluminum phosphate catalyst for a period of time from 15 minutes to 15 hours.

22. The method of claim 13 wherein step d) comprises reacting the at least one alkylene oxide with the at least one initiator molecule in the presence of the aluminum phosphate catalyst for a period of time sufficient to form a polyether polyol having an equivalent weight of from 100 to 10,000 Daltons.

23. The method of claim 13 wherein step d) comprises reacting the at least one alkylene oxide with the at least one initiator molecule in the presence of the aluminum phosphate catalyst at a temperature of from 95° to 150° C.

24. A polyether polyol formed according to a method comprising the steps of:
a) providing at least one alkylene oxide;
b) providing at least one initiator molecule having at least one alkylene oxide reactive hydrogen; and
c) reacting the at least one alkylene oxide with the at least one initiator molecule in the presence of an aluminum phosphate catalyst or residue thereof to form the polyether polyol.

25. The polyether polyol of claim 24 wherein step a) comprises providing ethylene oxide, propylene oxide, butylene oxide, epichlorohydrin or mixtures of these alkylene oxides.

26. The polyether polyol of claim 24 wherein step b) comprises providing as the at least one initiator molecule, an alcohol, a polyhydroxyl compound, a mixed hydroxyl and amine compound, an amine, a polyamine compound, or mixtures of these initiator molecules.

27. The polyether polyol of claim 24 wherein;
step b) comprises providing as the at least one initiator molecule, an oligomer comprising the reaction product of a pre-reaction initiator molecule with at least one alkylene oxide, and
step c) comprises using the oligomer as the initiator molecule.

28. The polyether polyol of claim 27 wherein the oligomer has a number average molecular weight of from 200 to 1,500 Daltons.

29. The polyether polyol of claim 24 wherein step c) comprises providing the aluminum phosphate catalyst in an amount of from 0.1 to 5.0 weight percent based on the total weight of the polyether polyol.

30. The polyether polyol of claim 24 wherein step c) comprises providing as the aluminum phosphate catalyst an aluminum phosphate having the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group.

31. The polyether polyol of claim 30 wherein R′ and R″ independently comprise one of an ethyl group, an ethoxy group, a propyl group, a propoxy group, a butyl group, a butoxy group, a phenyl group, or a phenoxy group.

32. The polyether polyol of claim 24 having an unsaturation of less than or equal to 0.020 meq KOH/g.

33. The polyether polyol of claim 24 having an equivalent weight of from 100 to 10,000 Daltons.

34. The polyether polyol of claim 24 comprising, after formation, the aluminum phosphate catalyst or residue thereof.

35. A polyether polyol formed according to a method comprising the steps of:
a) providing at least one alkylene oxide;
b) providing at least one initiator molecule having at least two alkylene oxide reactive hydrogens;
c) providing an aluminum phosphate catalyst having the general structure of P(O)(OAlR′R″)₃ wherein: O represents oxygen; P represents pentavalent phosphorous; Al represents aluminum; and R′ and R″ independently comprise a halide, an alkyl group, a haloalkyl group, an alkoxy group, an aryl group, an aryloxy group, or a carboxy group; and
d) reacting the at least one alkylene oxide with the at least one initiator molecule in the presence of the aluminum phosphate catalyst or residue thereof to form the polyether polyol.

36. The polyether polyol of claim 35 wherein step a) comprises providing ethylene oxide, propylene oxide, butylene oxide, epichlorohydrin or mixtures of these alkylene oxides.

37. The polyether polyol of claim 35 wherein step b) comprises providing as the at least one initiator molecule a polyhydroxyl compound, a mixed hydroxyl and amine compound, a polyamine compound, or mixtures of these initiator molecules.

38. The polyether polyol of claim 35 wherein;
step b) comprises providing as the at least one initiator molecule, an oligomer comprising the reaction product of a pre-reaction initiator molecule with at least one alkylene oxide, and
step c) comprises using the oligomer as the initiator molecule.

39. The polyether polyol of claim 38 wherein the oligomer has a number average molecular weight of from 200 to 1,500 Daltons.

40. The polyether polyol of claim 35 wherein step c) comprises providing the aluminum phosphate catalyst in an amount of from 0.1 to 5.0 weight percent based on the total weight of the polyether polyol.

41. The polyether polyol of claim 35 wherein R′ and R″ independently comprise one of an ethyl group, an ethoxy group, a propyl group, a propoxy group, a butyl group, a butoxy group, a phenyl group, or a phenoxy group.

42. The polyether polyol of claim 35 having an unsaturation of less than or equal to 0.020 meq KOH/g.

43. The polyether polyol of claim 35 having an equivalent weight of from 100 to 10,000 Daltons.

44. The polyether polyol of claim 35 comprising, after formation, the aluminum phosphate catalyst or residue thereof.
